(19) United States
(12) Patent Application Publication
(10) Pub. No.: US 2026/0085934 A1
(43) Pub. Date: Mar. 26, 2026

(54) MAGNETIC ANOMALY MAP MENDER

(71) Applicant: Honeywell International Inc., Charlotte, NC (US)

(72) Inventors: Carl Arthur Dins, Phoenix, AZ (US); Umut Orhan, Bothell, WA (US); Trevor Keith Stephens, Maple Grove, MN (US); Angel Sylvester, St. Louis Park, MN (US)

(73) Assignee: Honeywell International Inc., Charlotte, NC (US)

(21) Appl. No.: 19/263,304

(22) Filed: Jul. 8, 2025

Related U.S. Application Data
(60) Provisional application No. 63/699,596, filed on Sep. 26, 2024.

(51) Int. Cl. G01C 21/08; G01C 21/00; G01V 3/38; G06N 3/0464; G06N 3/08

(52) U.S. Cl. CPC G01C 21/08; G01C 21/3804; G01V 3/38; G06N 3/0464; G06N 3/08

(57) ABSTRACT

A method comprises selecting a first data set including a first magnetic anomaly map of a given area, the first map having a first accuracy; selecting a second data set including geological data for the given area; sending the first and second data sets to a machine learning model; and generating a second magnetic anomaly map of the given area based on the first and second data sets, the second map having a second accuracy higher than the first accuracy. The method further comprises comparing the second map with a ground truth map to train the machine learning model; and performing a validation test of the trained machine learning model by sending an additional data set including held-out magnetic anomaly map data to the machine learning model. In response to a validation threshold being met, the trained machine learning model is used to generate higher accuracy magnetic anomaly maps.

### CROSS REFERENCE TO RELATED APPLICATION

This application claims the benefit of and priority to U.S. Provisional Application No. 63/699,596, filed on Sep. 26, 2024, the disclosure of which is herein incorporated by reference.

### BACKGROUND

Magnetic anomaly navigation is a global navigation satellite system (GNSS)-denied navigation technique, in which measurements of magnetic anomalies are compared with geo-located magnetic anomaly maps. Magnetic anomalies include variations in the crustal field due to permanent or induced magnetized rock in the Earth. Magnetic anomalies are useful for navigation purposes because such anomalies are stable over time and exhibit high spatial frequency content.

The performance of a magnetic anomaly navigation system depends on the availability of accurate magnetic anomaly maps. Errors in magnetic anomaly maps can negatively impact navigation performance. Such errors can include missing magnetic anomaly values and poor georeferencing. For example, incorrectly geo-referenced map data can introduce large errors during operation of the navigation system.

### SUMMARY

A method comprises selecting a first data set including at least one first magnetic anomaly map of a given area, the at least one first magnetic anomaly map having a first accuracy; selecting a second data set including geological data for the given area; sending the first and second data sets to a machine learning model including a convolutional neural network; and generating at least one second magnetic anomaly map of the given area based on the first and second data sets, the at least one second magnetic anomaly map having a second accuracy that is higher than the first accuracy. The method further comprises comparing the at least one second magnetic anomaly map with at least one ground truth map of the given area to train the machine learning model; and performing a validation test of the trained machine learning model, using a validation threshold, by sending an additional data set including held-out magnetic anomaly map data to the trained machine learning model. In response to the validation threshold being met, the method uses the trained machine learning model to generate one or more higher accuracy magnetic anomaly maps of a selected area based on input magnetic anomaly map data.

### BRIEF DESCRIPTION OF THE DRAWINGS

Features of the present invention will become apparent to those skilled in the art from the following description with reference to the drawings. Understanding that the drawings depict only typical embodiments and are not therefore to be considered limiting in scope, the invention will be described with additional specificity and detail through the use of the accompanying drawings, in which:

FIG. 1A is a functional flow diagram of a method for providing a high-quality magnetic anomaly map, according to one implementation;

FIG. 1B is a schematic flow diagram of a process for providing high-quality magnetic anomaly maps using a machine learning model, according to one example;

FIGS. 2A-2C are examples of conventional magnetic anomaly maps and geology information that can be employed as inputs for training the machine learning model of FIG. 1B;

FIG. 3 is a flow diagram of a method for implementing and training the machine learning model, according to one example;

FIG. 4 is a block diagram of the machine learning model implemented with a U-Net architecture;

FIG. 5 is a flow diagram of a process for providing high-quality magnetic anomaly maps using the machine learning model, according to another example implementation;

FIGS. 6A-6C show a set of example magnetic anomaly maps that can be used for validation and training of the machine learning model;

FIG. 7 is a flow diagram of a method for testing performance of the machine learning model, according to an example implementation; and

FIG. 8 illustrates a visualization of test results from training the machine learning model when one of the maps from FIGS. 6A-6C is used as a validation map, and the other maps are used as training maps.

### DETAILED DESCRIPTION

In the following detailed description, embodiments are described in sufficient detail to enable those skilled in the art to practice the invention. It is to be understood that other embodiments may be utilized without departing from the scope of the invention. The following detailed description is, therefore, not to be taken in a limiting sense.

A method and system for providing a magnetic anomaly map mender are described herein. The present approach provides an artificial intelligence (AI) model that is configured to receive inputs of lesser quality magnetic anomaly maps, and to output higher quality magnetic anomaly maps.

The AI model can combine multiple data sources to provide for greater availability of the higher quality magnetic anomaly maps. The present approach provides for flexible integration of the multiple data sources to automatically generate the higher quality magnetic anomaly maps. The AI model can be used offline to generate the higher quality magnetic anomaly maps, which are then used for online navigation systems in a vehicle.

The present magnetic anomaly map mender can be implemented as a machine learning model that is operative to fuse multiple inputs to estimate higher accuracy magnetic anomaly maps. The machine learning model is trained with reference to high-quality/high-accuracy maps and is used offline to create a high-accuracy map. For example, the machine learning model can be run on the North American continent to yield a high-quality map, which can be embedded in vehicle navigation systems for use with onboard magnetic anomaly navigation algorithms.

In one example, the present system comprises at least one processor, a machine learning model including a convolutional neural network, with the machine learning model in operative communication with the processor, and a storage area for a magnetic anomaly map database. A processor readable medium has instructions, executable by the processor, to perform a method of generating an enhanced magnetic anomaly map for use in a magnetic anomaly navigation filter of a vehicle navigation system.

In one implementation, the method comprises generating a first data set including a first magnetic anomaly map of a given area and having a first accuracy; generating a second data set including geological data for the given area; and sending the first and second data sets to the machine learning model. The method automatically generates a second magnetic anomaly map of the given area based on the first and second data sets sent to the machine learning model, with the second magnetic anomaly map having a second accuracy that is higher than the first accuracy. The second magnetic anomaly map is compared with a ground truth map of the given area to train the machine learning model. After training, validation on held-out magnetic anomaly map data is performed, and if a validation threshold is met, then the machine learning model is deemed sufficient to be used to generate higher accuracy magnetic anomaly maps for areas where there is the necessary input data, but not necessarily where there is pre-existing high-accuracy ground truth map data. After using the machine learning model to generate higher accuracy magnetic anomaly maps, those maps may be stored in the magnetic anomaly map database.

In one embodiment, the magnetic anomaly map database can be located in a navigation processing unit onboard a vehicle. The navigation processing unit is operative to retrieve the stored magnetic anomaly map from the magnetic anomaly map database, and send the magnetic anomaly map to a magnetic anomaly navigation filter in the navigation processing unit to aid in navigating the vehicle.

Further details related to vehicle navigation systems that can use the present approach are described in U.S. application Ser. No. 19/212,193, titled BLIND SOURCE SEPARATION FOR MAGNETIC ANOMALY NAVIGATION, the disclosure of which is incorporated by reference herein. Such navigation systems can be used in various vehicles such as an aerial vehicle, a ground vehicle, a water vehicle, or the like. For example, the vehicle can be a crewed aircraft, an uncrewed aircraft, a ship, a submarine, or the like.

In some embodiments, the machine learning model can be extended to create vector maps, and to estimate the uncertainty of magnetic anomalies. In addition, text-based geology information can be integrated for training the machine learning model by use of various language models.

As the quality and availability of magnetic anomaly maps drive magnetic anomaly navigation performance, the present methods can provide improved GNSS-denied navigation over land or water.

Further details of various embodiments are described hereafter and with reference to the drawings.

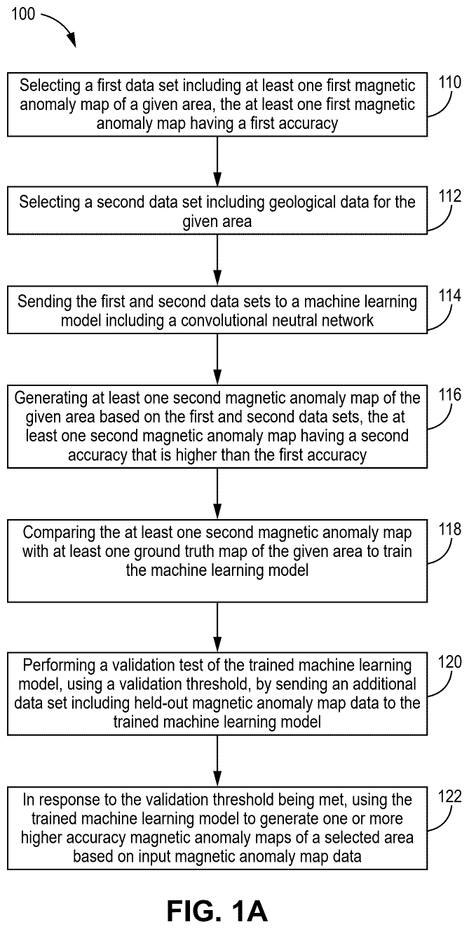

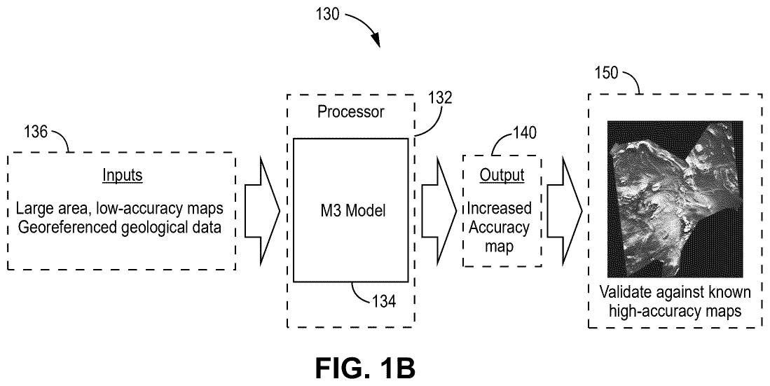

FIG. 1A is a functional flow diagram of a method 100 for providing a high-quality magnetic anomaly map, according to one implementation. The method 100 comprises selecting a first data set including at least one first magnetic anomaly map of a given area, the at least one first magnetic anomaly map having a first accuracy (block 110); and selecting a second data set including geological data for the given area (block 112). The method 100 then sends the first and second data sets to a machine learning model including a convolutional neural network (block 114), which generates at least one second magnetic anomaly map of the given area based on the first and second data sets, the at least one second magnetic anomaly map having a second accuracy that is higher than the first accuracy (block 116). The method 100 compares the at least one second magnetic anomaly map with at least one ground truth map of the given area to train the machine learning model (block 118).

The method 100 performs a validation test of the trained machine learning model, using a validation threshold, by sending an additional data set including held-out magnetic anomaly map data to the trained machine learning model (block 120). In response to the validation threshold being met, the method 100 uses the trained machine learning model to generate one or more higher accuracy magnetic anomaly maps of a selected area based on input magnetic anomaly map data (block 122). As described further hereafter, the higher accuracy magnetic anomaly maps can be stored in a magnetic anomaly map database for use in a vehicle navigation system.

FIG. 1B is a schematic flow diagram of a process 130 for providing a high-quality magnetic anomaly map, according to one example. A processor 132 hosts a magnetic map mender (M3) machine learning model 134 that is configured to receive a set of inputs 136 that include large area, low-accuracy maps, such as from the North American Magnetic Anomaly Database (NAMAD) and the Earth Magnetic Anomaly Grid (EMAG), as well as georeferenced geological data. As described further hereafter, the M3 machine learning model 134 is used offline, and is operative to automatically generate and output an increased accuracy map 140, which is then validated at 150 against one or more known high-accuracy maps. The M3 machine learning model 134 can be implemented with various neural networks, such as a convolutional neural network, a vision transformer model, or the like.

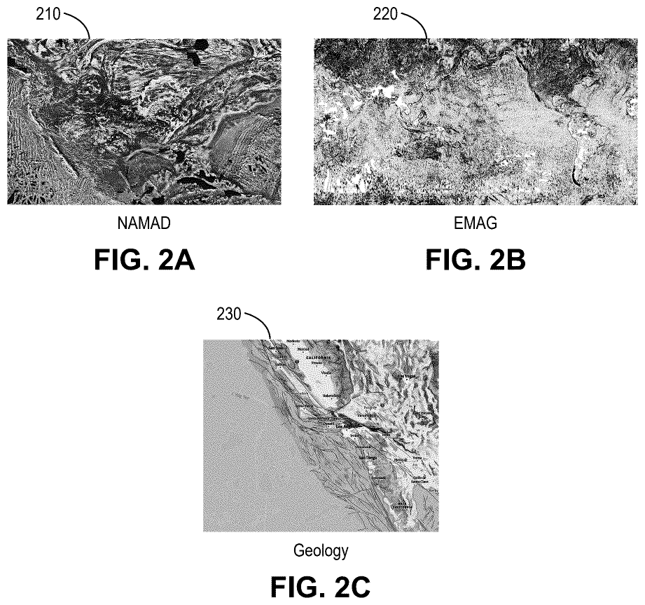

FIGS. 2A-2C are examples of conventional magnetic anomaly maps and geology information that can be employed as inputs for training the M3 machine learning model of FIG. 1B. The magnetic anomalies in magnetic anomaly maps are variations in the crustal field of the Earth due to permanent or induced magnetized rock. The magnetic anomalies are useful for navigation because they are stable over time and exhibit high spatial frequency content.

FIG. 2A is an example of a NAMAD map 210. While NAMAD maps have a higher resolution, these maps are problematic in geo-referencing and are only for North America. FIG. 2B is an example of a EMAG map 220. While EMAG maps have global coverage and include more recent geological surveys, EMAG maps have a lower resolution. FIG. 2C is an example of a geology map 230 that provides geological data. While geology maps can provide detailed information over land, the information they provide is sparse over water. Accordingly, the M3 machine learning model can be trained by combining the higher resolution of NAMAD maps with the geo-referenced accuracy of EMAG maps and the geological data.

The geological data needs to be encoded so that it is suitable for use by the M3 machine learning model. As geological data is available in text format, the M3 machine learning model needs vector inputs. The text descriptions of geological data can be encoded using AI or machine learning language models, such as small language models that are commercially available. Examples of geological data include information available from Macrostrat.org, which contains descriptions of rock units, geologic map polygons, and the like.

The inputs for use by the M3 machine learning model can be a grid of NAMAD and EMAG magnetic anomaly values, which are joined with vectors representing geological qualities. Through training, the M3 machine learning model can find correlations between the encoded geological data and magnetic anomaly values. For example, basement domains (rock layers) from geological data can be overlaid on a NAMAD map. Basement are crystalline rocks lying above the mantle and beneath other rocks and sediments of the Earth.

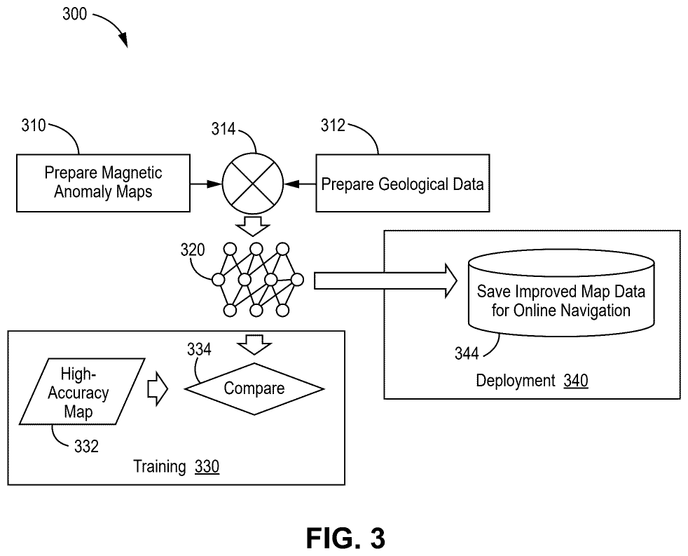

FIG. 3 is a flow diagram of a method 300 for implementing and training the M3 machine learning model, according to one example. The method 300 includes an offline procedure, in which a first data set of magnetic anomaly maps are selected and prepared (block 310), such as NAMAD maps, EMAG maps, and the like, for a given area. In addition, a second data set of geological data is selected and prepared for the given area (block 312). The first data set of magnetic anomaly maps and the second data set of geological data are joined in a mixer 314, and sent to a convolutional neural network (CNN) 320, such as U-Net, which is employed to implement the M3 machine learning model. The CNN 320 automatically generates and outputs an increased accuracy map based on the joined first and second data sets of magnetic anomaly maps and geological data.

A machine learning training module 330 operatively communicates with the CNN 320 and includes at least one high-accuracy map 332, such as a ground truth map for the given area. The machine learning training module 330 receives the increased accuracy map from CNN 320, and compares the increased accuracy map with the high-accuracy map 332 at block 334, to determine whether the increased accuracy map meets a validation threshold. In response to determining that the increased accuracy map meets the validation threshold in the machine learning training module 330, the CNN 320 sends the validated increased accuracy map to a storage area of a deployment module 340, where improved map data is saved for online navigation such as in a magnetic anomaly map database 344 for use in magnetic anomaly navigation of a vehicle.

As mentioned above, the M3 machine learning model can be implemented using a convolutional neural network such as U-Net. In U-Net, there is a contracting path and an expansive path, which gives the network a U-shaped architecture. The contracting path is a typical convolutional network that includes repeated application of convolutions, each followed by a rectified linear unit and a max pooling operation. During the contraction, the spatial information is reduced while feature information is increased. The expansive path combines the feature and spatial information through a sequence of up-convolutions and concatenations with high-resolution features from the contracting path.

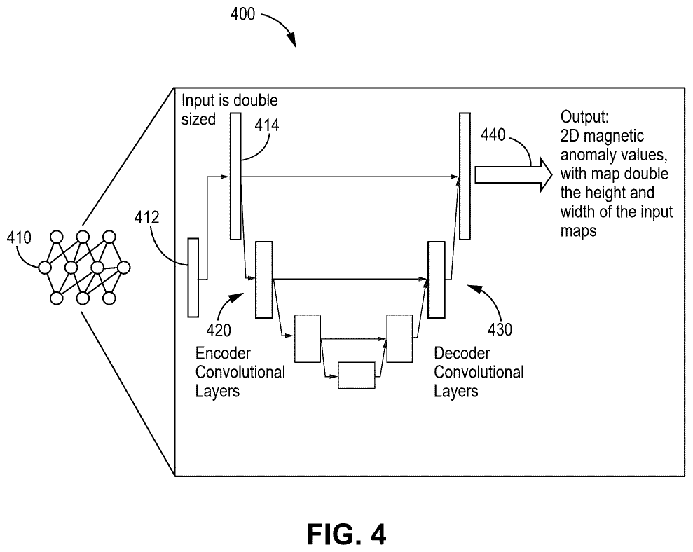

FIG. 4 is a block diagram 400 of the M3 machine learning model, which is implemented with a U-Net architecture 410. The U-Net architecture 410 includes an encoder side having a first set of convolutional layers 420, and a decoder side having a second set of convolutional layers 430. During operation, input map images 412 are double sized at 414, encoded through the first set of convolutional layers 420, and decoded through the second set of convolutional layers 430. An output 440 includes 2D magnetic anomaly values, with output map images having double the height and width of the input map image.

During training of the M3 machine learning model, low-resolution magnetic anomaly maps are sampled. The M3 machine learning model automatically generates and outputs magnetic anomaly maps that are at double resolution of the input maps. The output maps are then compared with corresponding high-resolution, high-accuracy maps. One success criteria is that the output maps from the M3 machine learning model beat linear interpolation results for low-resolution maps such as NAMAD maps.

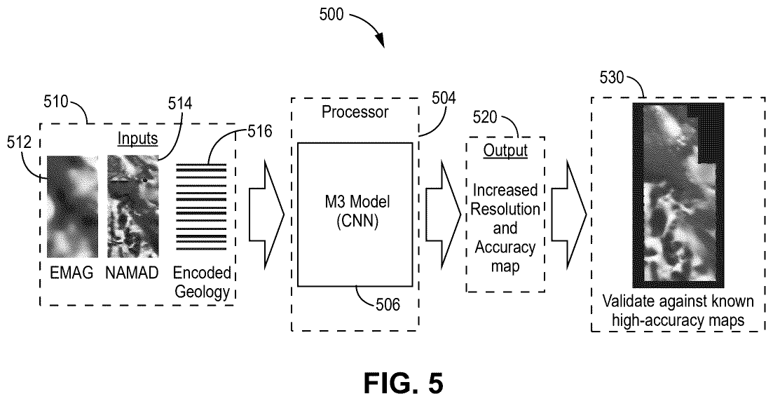

FIG. 5 is a schematic flow diagram of a process 500 for providing high-quality magnetic anomaly maps, according to another example implementation. A processor 504 hosts an M3 machine learning model 506, such as a CNN, which is configured to receive a set of inputs 510 that include an EMAG map image 512, a NAMAD map image 514, and encoded geology data 516 for training purposes. The EMAG map image 512 and the NAMAD map image 514 have the same size (dimensions). The M3 machine learning model 506 is operative to automatically generate and output an increased resolution and accuracy map at 520, which is then validated against one or more known high-accuracy maps at 530.

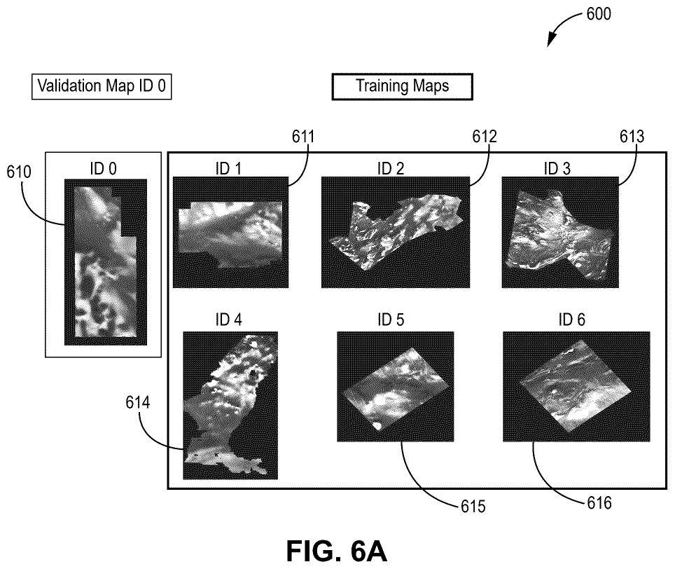

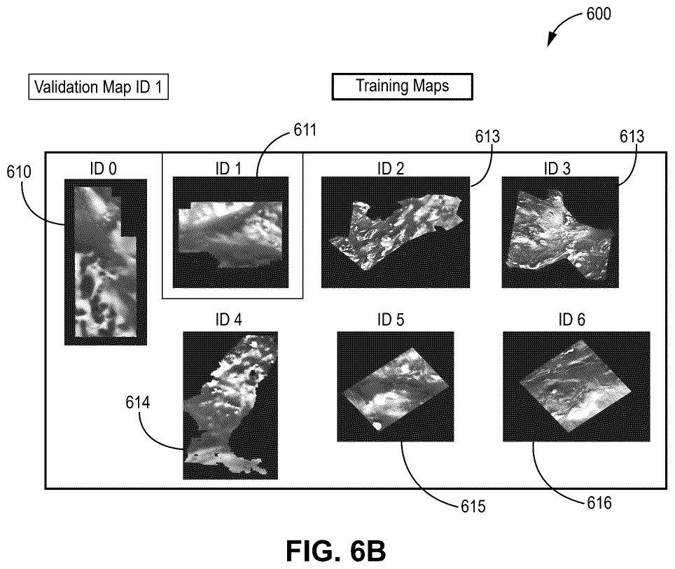

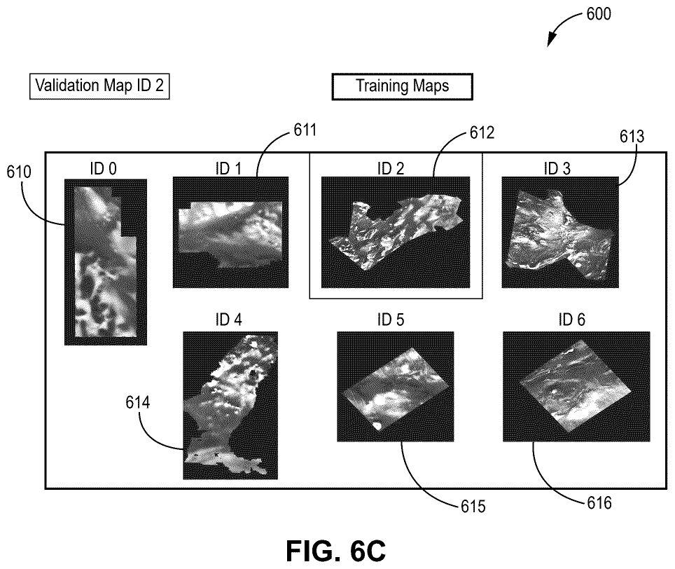

FIGS. 6A-6C show a set of example scalar magnetic anomaly maps 600, which can be used for validation and training of the M3 machine learning model. During each training iteration, one of the maps is respectively used for validation purposes, while the other maps are respectively used for training purposes.

For example, FIG. 6A shows that in a first training iteration, a map 610 (ID 0) is used as a validation map, while other maps 611 (ID 1), 612 (ID 2), 613 (ID 3), 614 (ID 4), 615 (ID 5), and 616 (ID 6) are used as training maps. FIG. 6B shows that in a second training iteration, the map 611 (ID 1) is used as a validation map, while the maps 610 (ID 0), 612 (ID 2), 613 (ID 3), 614 (ID 4), 615 (ID 5), and 616 (ID 6) are used as training maps. FIG. 6C shows that in a third training iteration, the map 612 (ID 2) is used as a validation map, while the maps 610 (ID 0), 611 (ID 1), 613 (ID 3), 614 (ID 4), 615 (ID 5), and 616 (ID 6) are used as training maps. This process can continue in subsequent training iterations, with different combinations of these maps being used for validation and training purposes.

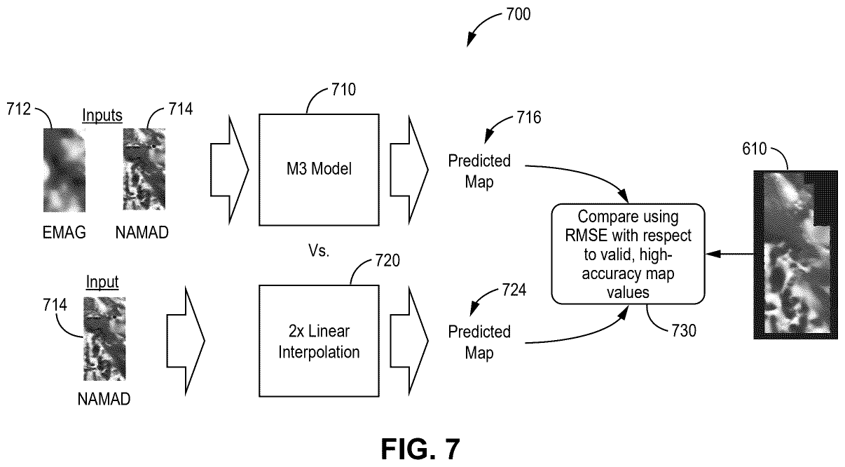

FIG. 7 is a flow diagram of a process 700 for testing performance of a M3 machine learning model 710, according to an example implementation. The M3 machine learning model 710 receives and samples a set of inputs that include an EMAG map image 712, and a NAMAD map image 714. The M3 machine learning model 710 generates and outputs a first predicted map 716. A 2× linear interpolation module 720 receives an input that includes the NAMAD map image 714. The 2× linear interpolation module 720 generates and outputs a second predicted map 724. The map values of the first and second predicted maps 716 and 724 are compared using root mean square error (RMSE) with respect to valid, high-accuracy map values (block 730), provided by a ground truth target map, such as a ground truth target map 610 (from FIG. 6A). In one embodiment, the input map images are sampled with a 0.01 degree grid, and the ground truth target map is sampled with a 0.005 degree grid. After training, the M3 machine learning model is scored relative to linear interpolation of the NAMAD map image.

Table 1 below summarizes the initial results from training the M3 machine learning model with the validation and training maps of FIGS. 6A-6C. As shown in Table 1, the M3 machine learning model provides improved magnetic anomaly maps over those from linear interpolation, when using validation maps 2, 3, 4 (corresponding to maps 612 (ID 2), 613 (ID 3), 614 (ID 4)).

TABLE 1

| Validation | M3 model can improve over linear |
|---|---|
| Map | interpolation |
| 0 | No |
| 1 | No |
| 2 | Yes |
| 3 | Yes |
| 4 | Yes |
| 5 | No |
| 6 | No |

Table 2 below lists further details of the analysis of training the M3 machine learning model with the validation and training maps of FIGS. 6A-6C. The largest improvement was found when map 614 (ID 4) was used as the validation map. As indicated, with EMAG and NAMAD images as inputs, the M3 machine learning model can realize improvements of 12% in RMSE relative to linear interpolation of the NAMAG image.

TABLE 2

| | Linear | | | |
|---|---|---|---|---|
| | Interpolation of | | M3 | M3 |
| Validation | NAMAD | M3 Model | Improvement | Improvement |
| Map | RMSE (nT) | RMSE (nT) | RMSE (nT) | (%) |
| 2 | 217.3 | 202.6 | 14.7 | 7% |
| 3 | 150.3 | 140.1 | 10.2 | 7% |
| 4 | 117.6 | 103.5 | 14.1 | 12% |

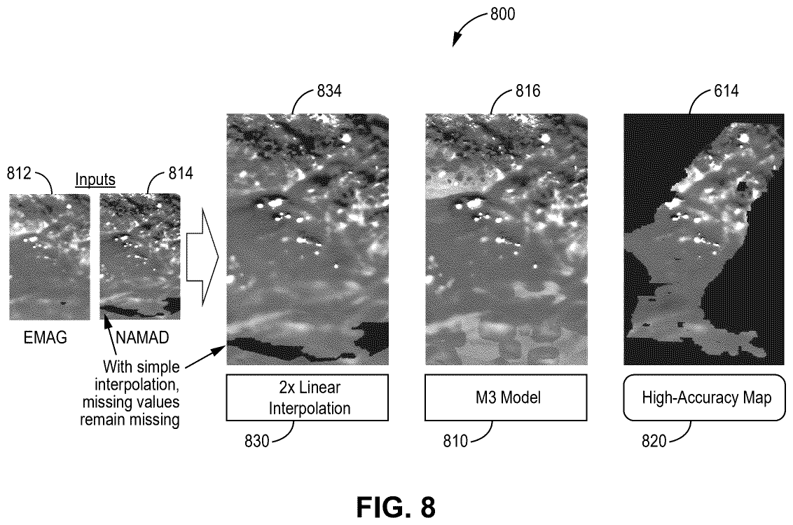

FIG. 8 illustrates a visualization 800 of test results from training a M3 machine learning model 810, using validation map 4 (corresponding to map 614 (ID 4)) as a high-accuracy validation map 820. The inputs include an EMAG map image 812 and a NAMAD map image 814. The M3 machine learning model 810 generates and outputs a corresponding map image 816, which is at least double in size with respect to the input map images. For example, the input map images 812 and 814 can each have a first height and a first width; and the output map image 816 can have a second height that is double the first height, and a second width that is double the first width.

A 2× linear interpolation module 830 generates and outputs a map image 834, which is the same size as the map image 816. As shown, missing values from the NAMAD map image 814 remain missing in the map image 834 after interpolation. In contrast, the M3 machine learning model 810 flexibly fuses the inputs to fix the gaps or errors (missing values) in the NAMAD map image, as shown in the map image 816.

The processing units and/or other computational devices used in the method and system described herein may be implemented using software, firmware, hardware, or appropriate combinations thereof. The processing unit and/or other computational devices may be supplemented by, or incorporated in, specially-designed application-specific integrated circuits (ASICs) or field programmable gate arrays (FPGAs). In some implementations, the processing unit and/or other computational devices may communicate through an additional transceiver with other computing devices outside of the navigation system, such as those associated with a management system or computing devices associated with other subsystems controlled by the management system. The processing unit and/or other computational devices can also include or function with software programs, firmware, or other computer readable instructions for carrying out various process tasks, calculations, and control functions used in the methods and systems described herein.

The methods described herein may be implemented by computer executable instructions, such as program modules or components, which are executed by at least one processor or processing unit. Generally, program modules include routines, programs, objects, data components, data structures, algorithms, and the like, which perform particular tasks or implement particular abstract data types.

Instructions for carrying out the various process tasks, calculations, and generation of other data used in the operation of the methods described herein can be implemented in software, firmware, or other computer readable instructions. These instructions are typically stored on appropriate computer program products that include non-transitory computer readable media used for storage of computer readable instructions or data structures. Such a computer readable medium may be available media that can be accessed by a general purpose or special purpose computer or processor, or any programmable logic device.

Suitable computer readable storage media may include, for example, non-volatile memory devices including semi-conductor memory devices such as Random Access Memory (RAM), Read Only Memory (ROM), Electrically Erasable Programmable ROM (EEPROM), or flash memory devices; magnetic disks such as internal hard disks or removable disks; optical storage devices such as compact discs (CDs), digital versatile discs (DVDs), Blu-ray discs; or any other media that can be used to carry or store desired program code in the form of computer executable instructions or data structures.

### EXAMPLE EMBODIMENTS

Example 1 includes a method comprising: selecting a first data set including at least one first magnetic anomaly map of a given area, the at least one first magnetic anomaly map having a first accuracy; selecting a second data set including geological data for the given area; sending the first and second data sets to a machine learning model including a convolutional neural network; generating at least one second magnetic anomaly map of the given area based on the first and second data sets, the at least one second magnetic anomaly map having a second accuracy that is higher than the first accuracy; comparing the at least one second magnetic anomaly map with at least one ground truth map of the given area to train the machine learning model; performing a validation test of the trained machine learning model, using a validation threshold, by sending an additional data set including held-out magnetic anomaly map data to the trained machine learning model; and in response to the validation threshold being met, using the trained machine learning model to generate one or more higher accuracy magnetic anomaly maps of a selected area based on input magnetic anomaly map data.

Example 2 includes the method of Example 1, further comprising storing the one or more higher accuracy magnetic anomaly maps in a magnetic anomaly map database.

Example 3 includes the method of any of Examples 1-2, wherein the at least one first magnetic anomaly map comprises at least one North American Magnetic Anomaly Database (NAMAD) map, or at least one Earth Magnetic Anomaly Grid (EMAG) map.

Example 4 includes the method of any of Examples 1-3, wherein the convolutional neural network comprises a U-Net architecture.

Example 5 includes the method of any of Examples 1-4, wherein the at least one first magnetic anomaly map has a first height and a first width; and the at least one second magnetic anomaly map has a second height that is double the first height, and a second width that is double the first width.

Example 6 includes the method of any of Examples 1-5, further comprising training the machine learning model to find correlations between encoded geological data and magnetic anomaly values.

Example 7 includes the method of any of Examples 2-6, wherein the magnetic anomaly map database is located in a navigation processing unit onboard a vehicle.

Example 8 includes the method of Example 7, further comprising retrieving the one or more higher accuracy magnetic anomaly maps from the magnetic anomaly map database; and using the one or more higher accuracy magnetic anomaly maps in a magnetic anomaly navigation filter in the navigation processing unit to aid in navigating the vehicle.

Example 9 includes the method of any of Examples 7-8, wherein the vehicle is an aerial vehicle.

Example 10 includes the method of any of Examples 7-8, wherein the vehicle comprises a crewed aircraft, or an uncrewed aircraft.

Example 11 includes the method of any of Examples 7-8, wherein the vehicle comprises a ground vehicle, or a water vehicle.

Example 12 includes a system comprising: at least one processor; a machine learning model including a convolutional neural network, the machine learning model in operative communication with the at least one processor; and a processor readable medium have instructions, executable by the at least one processor, to perform a method of generating an enhanced magnetic anomaly map for use in a magnetic anomaly navigation filter of a vehicle navigation system, the method comprising: generating a first data set including at least one first magnetic anomaly map of a given area, the at least one first magnetic anomaly map having a first accuracy; generating a second data set including geological data for the given area; sending the first and second data sets to the machine learning model; generating at least one second magnetic anomaly map of the given area based on the first and second data sets sent to the machine learning model, the at least one second magnetic anomaly map having a second accuracy that is higher than the first accuracy; comparing the at least one second magnetic anomaly map with at least one ground truth map of the given area to train the machine learning model; and performing a validation test of the trained machine learning model, using a validation threshold, by sending an additional data set including held-out magnetic anomaly map data to the trained machine learning model; wherein in response to the validation threshold being met, the trained machine learning model is deemed sufficient to generate one or more higher accuracy magnetic anomaly maps of selected areas based on input magnetic anomaly map data.

Example 13 includes the system of Example 12, wherein the one or more higher accuracy magnetic anomaly maps are stored in a magnetic anomaly map database when generated.

Example 14 includes the system of any of Examples 12-13, wherein the at least one first magnetic anomaly map comprises at least one North American Magnetic Anomaly Database (NAMAD) map, or at least one Earth Magnetic Anomaly Grid (EMAG) map.

Example 15 includes the system of any of Examples 12-14, wherein the convolutional neural network comprises a U-Net architecture.

Example 16 includes the system of any of Examples 12-15, wherein the at least one first magnetic anomaly map has a first height and a first width; and the at least one second magnetic anomaly map has a second height that is double the first height, and a second width that is double the first width.

Example 17 includes the system of any of Examples 12-16, wherein the machine learning model is trained to find correlations between encoded geological data and magnetic anomaly values.

Example 18 includes the system of any of Examples 13-17, wherein the magnetic anomaly map database is located in a navigation processing unit onboard a vehicle.

Example 19 includes the system of Example 18, wherein the navigation processing unit is operative to retrieve the one or more higher accuracy magnetic anomaly maps from the magnetic anomaly map database; and use the one or more higher accuracy magnetic anomaly maps in a magnetic anomaly navigation filter in the navigation processing unit to aid in navigating the vehicle.

Example 20 includes the system of any of Examples 18-19, wherein the vehicle comprises an aerial vehicle, a ground vehicle, or a water vehicle.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A method comprising:
selecting a first data set including at least one first magnetic anomaly map of a given area, the at least one first magnetic anomaly map having a first accuracy;
selecting a second data set including geological data for the given area;
sending the first and second data sets to a machine learning model including a convolutional neural network;
generating at least one second magnetic anomaly map of the given area based on the first and second data sets, the at least one second magnetic anomaly map having a second accuracy that is higher than the first accuracy;
comparing the at least one second magnetic anomaly map with at least one ground truth map of the given area to train the machine learning model;
performing a validation test of the trained machine learning model, using a validation threshold, by sending an additional data set including held-out magnetic anomaly map data to the trained machine learning model; and
in response to the validation threshold being met, using the trained machine learning model to generate one or more higher accuracy magnetic anomaly maps of a selected area based on input magnetic anomaly map data.

2. The method of claim 1, further comprising storing the one or more higher accuracy magnetic anomaly maps in a magnetic anomaly map database.

3. The method of claim 1, wherein the at least one first magnetic anomaly map comprises at least one North American Magnetic Anomaly Database (NAMAD) map, or at least one Earth Magnetic Anomaly Grid (EMAG) map.

4. The method of claim 1, wherein the convolutional neural network comprises a U-Net architecture.

5. The method of claim 1, wherein:
the at least one first magnetic anomaly map has a first height and a first width; and
the at least one second magnetic anomaly map has a second height that is double the first height, and a second width that is double the first width.

6. The method of claim 1, further comprising:
training the machine learning model to find correlations between encoded geological data and magnetic anomaly values.

7. The method of claim 2, wherein the magnetic anomaly map database is located in a navigation processing unit onboard a vehicle.

8. The method of claim 7, further comprising:
retrieving the one or more higher accuracy magnetic anomaly maps from the magnetic anomaly map database; and
using the one or more higher accuracy magnetic anomaly maps in a magnetic anomaly navigation filter in the navigation processing unit to aid in navigating the vehicle.

9. The method of claim 7, wherein the vehicle is an aerial vehicle.

10. The method of claim 7, wherein the vehicle comprises a crewed aircraft, or an uncrewed aircraft.

11. The method of claim 7, wherein the vehicle comprises a ground vehicle, or a water vehicle.

12. A system comprising:
at least one processor;
a machine learning model including a convolutional neural network, the machine learning model in operative communication with the at least one processor; and
a processor readable medium have instructions, executable by the at least one processor, to perform a method of generating an enhanced magnetic anomaly map for use in a magnetic anomaly navigation filter of a vehicle navigation system, the method comprising:
generating a first data set including at least one first magnetic anomaly map of a given area, the at least one first magnetic anomaly map having a first accuracy;
generating a second data set including geological data for the given area;
sending the first and second data sets to the machine learning model;
generating at least one second magnetic anomaly map of the given area based on the first and second data sets sent to the machine learning model, the at least one second magnetic anomaly map having a second accuracy that is higher than the first accuracy;
comparing the at least one second magnetic anomaly map with at least one ground truth map of the given area to train the machine learning model; and
performing a validation test of the trained machine learning model, using a validation threshold, by sending an additional data set including held-out magnetic anomaly map data to the trained machine learning model;
wherein in response to the validation threshold being met, the trained machine learning model is deemed sufficient to generate one or more higher accuracy magnetic anomaly maps of selected areas based on input magnetic anomaly map data.

13. The system of claim 12, wherein the one or more higher accuracy magnetic anomaly maps are stored in a magnetic anomaly map database when generated.

14. The system of claim 12, wherein the at least one first magnetic anomaly map comprises at least one North American Magnetic Anomaly Database (NAMAD) map, or at least one Earth Magnetic Anomaly Grid (EMAG) map.

15. The system of claim 12, wherein the convolutional neural network comprises a U-Net architecture.

16. The system of claim 12, wherein:
the at least one first magnetic anomaly map has a first height and a first width; and
the at least one second magnetic anomaly map has a second height that is double the first height, and a second width that is double the first width.

17. The system of claim 12, wherein the machine learning model is trained to find correlations between encoded geological data and magnetic anomaly values.

18. The system of claim 13, wherein the magnetic anomaly map database is located in a navigation processing unit onboard a vehicle.

19. The system of claim 18, wherein the navigation processing unit is operative to:
retrieve the one or more higher accuracy magnetic anomaly maps from the magnetic anomaly map database; and
use the one or more higher accuracy magnetic anomaly maps in a magnetic anomaly navigation filter in the navigation processing unit to aid in navigating the vehicle.

20. The system of claim 18, wherein the vehicle comprises an aerial vehicle, a ground vehicle, or a water vehicle.
